(19) United States
(12) Patent Application Publication
(10) Pub. No.: US 2009/0225016 A1
(43) Pub. Date: Sep. 10, 2009

(54) LIGHT-SENSITIVE DRIVING CIRCUIT, LIGHT-SENSITIVE METHOD AND DISPLAY

(75) Inventors: Chih-Chang Lai, Taichung County (TW); Wen-Chun Wang, Taichung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/400,045

(22) Filed: Mar. 9, 2009

(30) Foreign Application Priority Data
Mar. 10, 2008 (TW) 97108403
May 28, 2008 (CN) 200810109353.X

(51) Int. Cl. G09G 3/36; H05B 37/02

(52) U.S. Cl. 345/87; 315/158

(57) ABSTRACT

A light-sensitive driving circuit, a light-sensitive driving method and a display are provided. The light-sensitive driving circuit comprises a pulse width modulation circuit, a judge unit and a first analog-to-digital converter. The pulse width modulation circuit provides a pulse width modulation voltage to drive a light-sensitive apparatus, so that the light-sensitive apparatus outputs an induced signal according to an external light. The judge unit judges whether a check and burn procedure needs to be operated or not according to an external command. If the check and burn procedure does not need to be operated, the first analog-to-digital converter outputs a digital signal according to the induced signal.

This application claims the benefit of Taiwan application Serial No. 97108403, filed Mar. 10, 2008, the subject matter of which is incorporated herein by reference.

### BACKGROUND OF THE INVENTION

1. Field of the Invention

The invention relates in general to a light-sensitive driving circuit, and more particularly to a light-sensitive driving circuit capable of prolonging the lifespan of the light-sensitive apparatus, a light-sensitive driving method and a display.

2. Description of the Related Art

For the backlight luminance of the display device, most conventional technologies directly apply a fixed voltage to drive the light-sensitive apparatus and adjust the backlight luminance of display device according to a signal outputted by the light-sensitive apparatus.

If the thin film transistor of the light-sensitive apparatus is conducted over a long duration, I-V curve drift will occur, and this is called stress effect, which increases the threshold voltage Vth of the thin film transistor and jeopardizes the current driving ability of the thin film transistor. When the threshold voltage Vth of the thin film transistor is larger than a pre-determined value, the thin film transistor cannot be driven, and the lifespan of the light-sensitive apparatus will be reduced.

### SUMMARY OF THE INVENTION

The invention is directed to a light-sensitive driving circuit, a light-sensitive driving method and a display. The light-sensitive driving circuit outputs a pulse width modulation voltage to drive the light-sensitive apparatus, so as to avoid the stress effect, which occurs when a light-sensitive apparatus is driven by a fixed voltage, and prolong the lifespan of the light-sensitive apparatus.

According to a first aspect of the present invention, a light-sensitive driving circuit comprising a pulse width modulation (PWM) circuit, a judge unit and a first analog-to-digital converter is provided. The pulse width modulation circuit provides a pulse width modulation voltage to drive the light-sensitive apparatus, so that the light-sensitive apparatus outputs an induced signal according to an external light. The judge unit judges whether a check and burn procedure needs to be operated or not according to an external command. If the check and burn procedure does not need to be operated, the first analog-to-digital converter outputs a digital signal according to the induced signal.

According to a second aspect of the present invention, a light-sensitive driving method comprising the following steps is provided. Firstly, a pulse width modulation voltage is provided to drive the light-sensitive apparatus, so that the light-sensitive apparatus outputs an induced signal according to an external light. Next, whether a check and burn procedure needs to be operated or not is judged according to an external command. Lastly, if the check and burn procedure does not need to be operated, the analog-to-digital converter converts the induced voltage to a digital signal and then the digital signal is further outputted.

The invention will become apparent from the following detailed description of the preferred but non-limiting embodiments. The following description is made with reference to the accompanying drawings.

### BRIEF DESCRIPTION OF THE DRAWINGS

FIG. 1 shows a display with the function of dynamically adjusting backlight luminance;

FIG. 2 shows a block diagram of a light-sensitive apparatus, a light-sensitive driving circuit and a backlight module;

FIG. 3 shows a wave-pattern of a pulse width modulation voltage and an induced voltage;

FIG. 4 shows a light-sensitive apparatus and a light-sensitive driving circuit according to a first embodiment of the invention;

FIG. 5 shows a light-sensitive apparatus and a light-sensitive driving circuit according to a second embodiment of the invention; and

FIG. 6 shows a flowchart of a light-sensitive driving method according to a preferred embodiment of the invention.

### DETAILED DESCRIPTION OF THE INVENTION

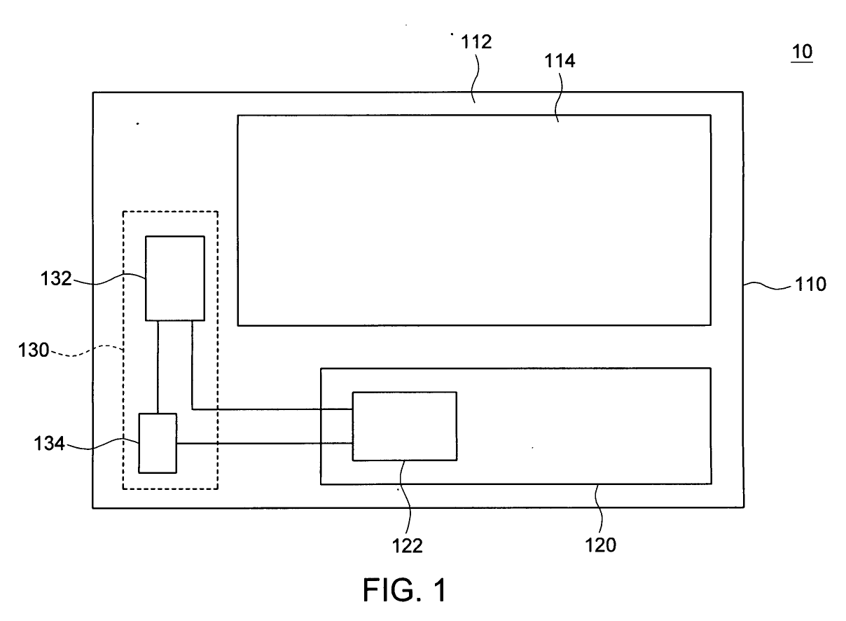

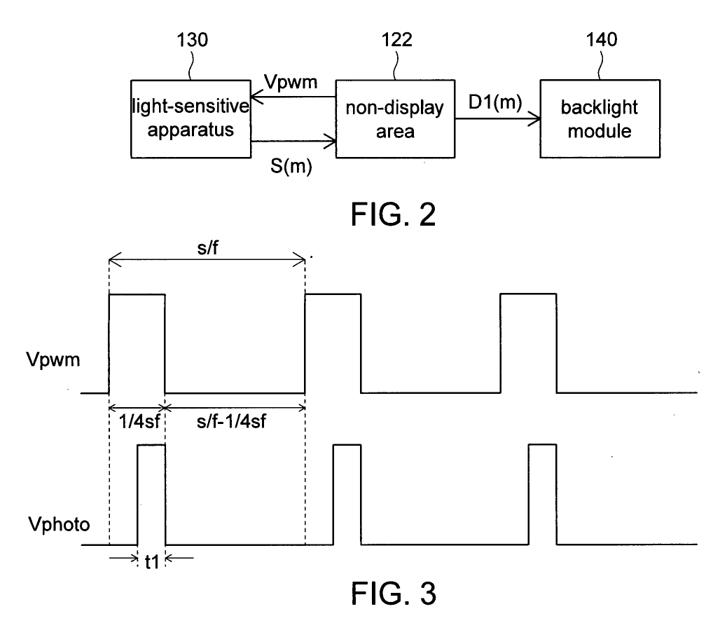

Referring to both FIG. 1 and FIG. 2. FIG. 1 shows a display with the function of dynamically adjusting backlight luminance. FIG. 2 shows a block diagram of a light-sensitive apparatus, a light-sensitive driving circuit and a backlight module. The display 10 comprises a display panel 110, a display driving integrated circuit 120, a light-sensitive apparatus 130 and a backlight module 140, wherein the display panel 110 comprises a non-display area 112 (also called “peripheral area”) and a display area 114 (also called “active area”). The display driving integrated circuit 120 and the light-sensitive apparatus 130, for example, are disposed within the non-display area 112 or on a circuit board (not illustrated).

The display driving integrated circuit 120 further comprises a light-sensitive driving circuit 122, which outputs a pulse width modulation voltage Vpwm to drive the light-sensitive apparatus 130, so that the light-sensitive apparatus 130 outputs an induced signal S(m) according to an external light. The light-sensitive driving circuit 122 outputs a digital signal D1(m) according to the induced signal S(m) to dynamically adjust the backlight luminance of the backlight module 140, wherein symbol m denotes the surrounding luminance of the external light.

The abovementioned induced signal S(m) is an induced voltage or an induced current, and the light-sensitive driving circuit 122 and the light-sensitive apparatus 130 can be implemented in many ways. The light-sensitive driving circuit 122 and the light-sensitive apparatus 130 are further elaborated in a first embodiment and a second embodiment below.

The light-sensitive apparatus 130 further comprises a light-sensing element 132 and a current-to-voltage element 134. The light-sensing element 132 generates a current according to an external light, and the current-to-voltage element 134 outputs an induced voltage Vphoto(m) according to the current Iphoto(m). The light-sensitive driving circuit 122 outputs a digital signal D1(m) according to the induced voltage Vphoto(m) to dynamically adjust the backlight luminance of the backlight module 140, wherein m denotes the surrounding luminance of the external light.

Referring to FIG. 3, a wave-pattern of a pulse width modulation voltage and an induced voltage is shown. The light-sensitive apparatus 130, for example, is constituted by one or more thin film transistors. If the thin film transistor is conducted over a long duration, I-V curve drift will occur, and this is called stress effect, which increases the threshold voltage Vth of the thin film transistor and jeopardizes the current driving ability of the thin film transistor. The thin film transistor cannot be driven when the threshold voltage Vth of the thin film transistor is larger than a pre-determined value.

To avoid the thin film transistor being conducted over a long duration, the light-sensitive driving circuit 122 of the present embodiment of the invention does not use a fixed voltage to drive the light-sensitive apparatus 130, but preferably outputs a pulse width modulation voltage Vpwm to drive the light-sensitive apparatus 130 so as to reduce the stress effect occurring to the thin film transistor.

For example, the pulse width modulation voltage Vpwm outputted by the pulse width modulation circuit 1222 has a cycle equaling

$$\frac{s}{f} ,$$

and a working cycle equaling

$$\frac{1}{4 sf} ,$$

wherein symbol s denotes the times of pulse width modulation voltage outputted by the pulse width modulation circuit 1222 per second, and symbol f denotes the frame updating rate.

The light-sensitive apparatus 130 receives a pulse width modulation voltage Vpwm, and the working cycle of the pulse width modulation voltage Vpwm can be appropriately adjusted according to the properties of the product. Thus, the stress effect occurring to thin film transistor is reduced and the lifespan of the light-sensitive apparatus 130 is prolonged.

### First Embodiment

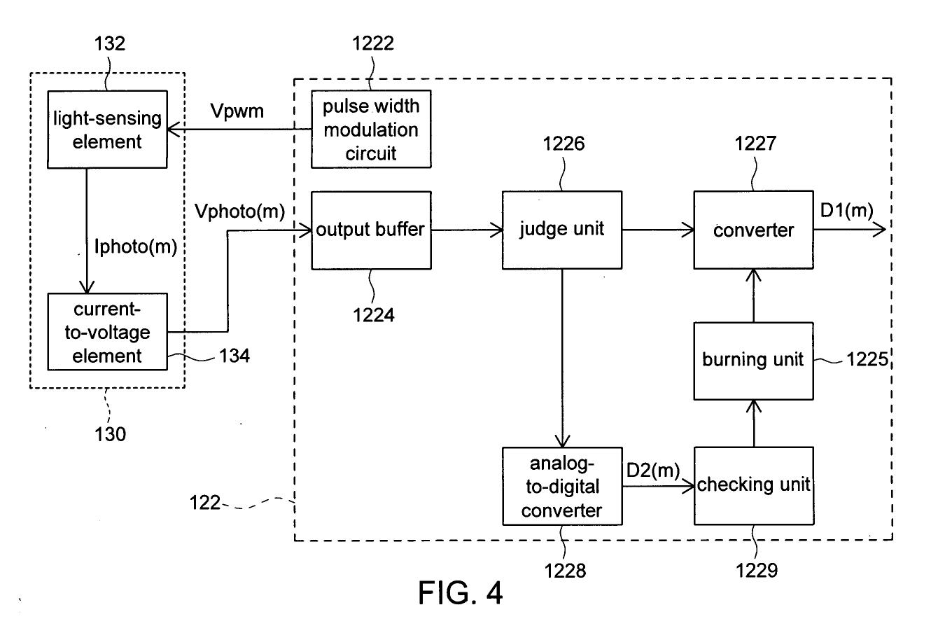

Referring to FIG. 4, a light-sensitive apparatus and a light-sensitive driving circuit according to a first embodiment of the invention is shown. The light-sensitive driving circuit 122 and the light-sensitive apparatus 130 can be implemented in many ways. In the first embodiment, the light-sensitive 5 apparatus 130 comprises a light-sensing element 132 and a current-to-voltage element 134. The light-sensitive driving circuit 122 comprises a pulse width modulation (PWM) circuit 1222, an output buffer 1224, a burning unit 1225, a judge unit 1226, an analog-to-digital converter 1227, an analog-to-digital converter 1228 and a checking unit 1229.

When the induced signal S(m) of FIG. 2 is an induced voltage, the pulse width modulation circuit 1222 provides a pulse width modulation voltage Vpwm to drive light-sensing element 132 of the light-sensitive apparatus 130, so that the surrounding luminance m of the external light of the light-sensing element 132 outputs a corresponding induced current Iphoto(m) to the current-to-voltage element 134. The current-to-voltage element 134 outputs a corresponding induced voltage Vphoto(m) to the buffer 1224 according to the induced current Iphoto(m), and the output buffer 1224 increases the pushing force for outputting the induced voltage Vphoto(m).

The judge unit 1226 judges whether to operate a check and burn procedure according to an external command. If the check and burn procedure does not need to be operated, the analog-to-digital converter 1227 converts the induced voltage Vphoto(m) to a digital signal D1(m) and further outputs the digital signal D1(m) to dynamically adjust the backlight luminance of the backlight module 140.

To the contrary, if the check and burn procedure needs to be operated, the system end (not shown) designates that the surrounding luminance m of the external light equals ml. Meanwhile, the induced voltage Vphoto(m) outputted by the light-sensitive apparatus 130 equals a first analog value Vphoto(m1), and the analog-to-digital converter 1228 outputs a first digital value D(m1) according to the first analog value Vphoto(m1). Next, the system end indicates that the surrounding luminance m of the external light equals m2. Meanwhile, the induced voltage Vphoto(m) outputted by the light-sensitive apparatus 130 equals a second analog value Vphoto(m2), and the analog-to-digital converter 1228 outputs a second digital value D(m2) according to the second analog value Vphoto(m2).

The checking unit 1229 checks whether the difference between the first digital value D(m1) and the second digital value D(m2) is larger than a checking value. If the value of [D(m1)-D(m2)] is not larger than checking value, this implies that the light-sensitive apparatus 130 is a defective product. To the contrary, if the value of [D(m1)-D(m2)] is larger than checking value, this implies that the light-sensitive apparatus 130 is an accepted product. When the value of [D(m1)-D(m2)] is larger than checking value, the burning unit 1225 burns the first digital value D(m1) and the second digital value D(m2) to the analog-to-digital converter 1227 to determine an output voltage range of the analog-to-digital converter 1227.

For example, the system end designates that the surrounding luminance m of the external light equals 10000 Lux. Meanwhile, the induced voltage Vphoto (m) outputted by the light-sensitive apparatus 130 equals a first analog value 2.2V, and the analog-to-digital converter 1228 outputs a first digital value D(10000) according to the first analog value 2.2V. Next, the system end designates that the surrounding luminance m of the external light equals 0 Lux. Meanwhile, the induced voltage Vphoto (m) outputted by the light-sensitive apparatus 130 equals a second analog value 1.1V, and the analog-to-digital converter 1228 outputs a second digital value D(10) according to the second analog value 1.1V.

When the order of the analog-to-digital converter 1227 is 32 and the precision level is 0.02V, the value of [Vphoto(10000)-Vphoto(10)] must larger than 0.64V, otherwise the analog-to-digital converter 1227 cannot decode 32-order digital signal. Thus, the checking unit 1229 judges whether the value of [Vphoto(10000)-Vphoto(10)] is larger than 0.64V according to whether the value of [D(10000)-D(10)] is larger than a predetermined checking value. When the value of [D(10000)-D(10)] is larger than the predetermined checking value, the first digital value D(10000) and the second digital value D(10) will be burnt to the analog-to-digital converter 1227. Meanwhile, the first digital value D(10000) is a maximum output of the analog-to-digital converter 1227 and the second digital value D(10) is a minimum output of the analog-to-digital converter 1227.

The analog-to-digital converter 1227 establishes an output voltage range according to the characteristics of the light-sensitive apparatus 130 of the display panel 110, hence resolving the problem that given the same luminance, the digital signal outputted by the light-sensitive apparatus 130 disposed on different display panels is different.

The embodiment disclosed above can further burn more digital value to the analog-to-digital converter 1227 according to customers' needs to determine other output voltage ranges of the analog-to-digital converter 1227. For example, given that the surrounding luminance equals 10 Lux, 1000 Lux, 100 Lux and 100 Lux, the induced voltage Vphoto(m) respectively equal a first analog value Vphoto(10), a second analog value Vphoto(10000), a third analog value Vphoto(100) and a fourth analog value Vphoto(1000). The analog-to-digital converter 1228 respectively converts the first analog value Vphoto(10), the second analog value Vphoto(10000), the third analog value Vphoto(100) and the fourth analog value Vphoto(1000) to a first digital value D(10), a second digital value D(10000), a third digital value D(100) and a fourth digital value D(1000). The first digital value D(10), the second digital value D(10000), the third digital value D(100) and the fourth digital value D(1000) are burnt to the analog-to-digital converter 1227 to determine three output voltage ranges of the analog-to-digital converter 1227. 100311 Within the range between the first digital value D(10) and the third digital value D(100) or the range between the fourth digital value D(1000) and the second digital value D(10000), the digital signal can be flexibly adjusted to have smaller order such as 8 or 16 when corresponding surrounding luminance becomes darker or brighter. The digital signal within the range between the third digital value D(100) and the fourth digital value D(1000) can be flexibly switched to have higher order to fit customers' needs.

### Second Embodiment

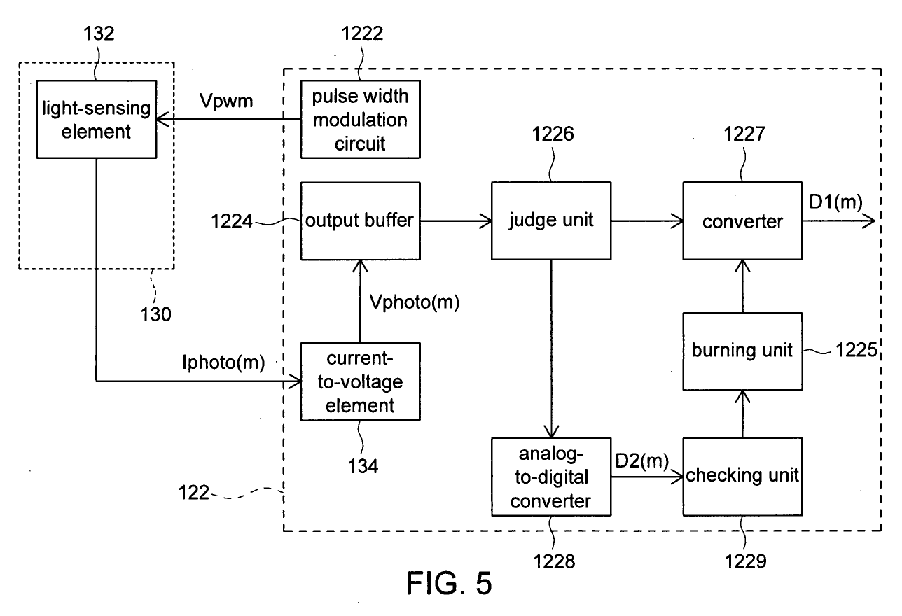

Referring to FIG. 5, a light-sensitive apparatus and a light-sensitive driving circuit according to a second embodiment of the invention is shown. The light-sensitive driving circuit 122 and the light-sensitive apparatus 130 can be implemented by way of the first embodiment or the second embodiment. In the second embodiment, the light-sensitive apparatus 130 comprises a light-sensing element 132, and the light-sensitive driving circuit 122 comprises a current-to-voltage element 134, a pulse width modulation (PWM) circuit 1222, an output buffer 1224, a burning unit 1225, a judge unit 1226, an analog-to-digital converter 1227, an analog-to-digital converter 1228 and a checking unit 1229.

When the induced signal S(m) of FIG. 2 is an induced current, the light-sensitive apparatus 130 of the second embodiment does not comprise the current-to-voltage element 134, but instead, integrates the current-to-voltage element 134 into the light-sensitive driving circuit 122. The pulse width modulation circuit 1222 provides a pulse width modulation voltage Vpwm to drive the light-sensing element 132 of the light-sensitive apparatus 130, so that the surrounding luminance m of the external light of the light-sensing element 132 outputs a corresponding induced current Iphoto(m) to the light-sensitive driving circuit 122. The light-sensitive driving circuit 122 receives an induced current Iphoto(m), and the current-to-voltage element 134 of the light-sensitive driving circuit 122 converts the induced current Iphoto(m) to an induced voltage Vphoto(m) which is outputted to the output buffer 1224.

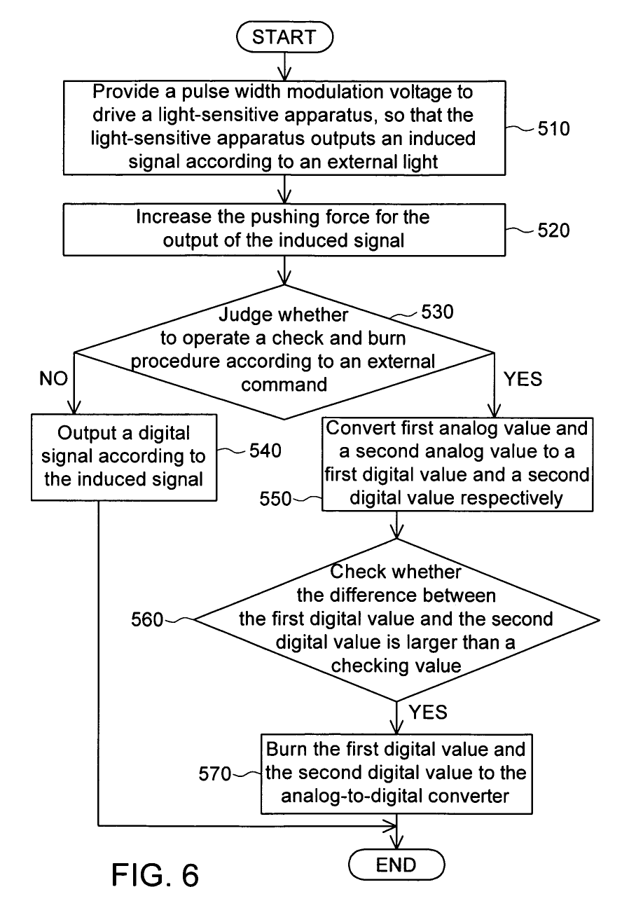

Referring to FIG. 6, a flowchart of a light-sensitive driving method according to a preferred embodiment of the invention is shown. The light-sensitive driving method is used in the display 10. The light-sensitive driving method comprises the following steps:

Firstly, the method begins at step 510, the pulse width modulation circuit 1222 provides a pulse width modulation voltage Vpwm to drive the light-sensitive apparatus 130, so that the light-sensitive apparatus 130 outputs an induced signal S(m) according to an external light. Next, the method proceeds to step 520, the output buffer 1224 increases the pushing force for outputting the induced signal S(m). Then, the method proceeds to step 530, the judge unit 1226 judges whether a check and burn procedure needs to be operated or not according to an external command. If the check and burn procedure does not need to be operated, the method proceeds to step 540, the analog-to-digital converter 1227 outputs a digital signal D1(m) according to the induced signal S(m).

To the contrary, if the check and burn procedure needs to be operated, the method proceeds to step 550, the analog-to-digital converter 1228 respectively converts the first analog value Vphoto(m1) and the second analog value Vphoto(m2) to a first digital value D1(m1) and a second digital value D1(m2). Then, the method proceeds to step 560, the checking unit 1229 checks whether the difference between the first digital value D1(m1) and the second digital value D1(m2) is larger than a checking value. If the difference between the first digital value D1(m1) and the second digital value D1(m2) is larger than a checking value, the first digital value D1(m1) and the second digital value D1(m2) are burnt to the analog-to-digital converter 1227 to determine an output voltage range of the analog-to-digital converter 1227.

The light-sensitive driving circuit, the light-sensitive driving method and the display disclosed in the above embodiment of the invention at least have the following advantages.

Firstly, the lifespan of the light-sensitive apparatus is prolonged.

Secondly, the problem that given the same luminance, the digital signal outputted by the light-sensing element disposed on different display panels is different is resolved.

Thirdly, the invention has a checking function to assure that the light-sensitive apparatus functions normally.

Fourthly, the invention has a burning function and is capable of determining the output voltage range of the analog-to-digital converter according to the characteristics of the light-sensing element of the display panel.

Fifthly, the digital signal can be flexibly switched to different orders according to different output voltage ranges to meets customers' needs

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light-sensitive driving circuit, comprising:
a pulse width modulation (PWM) circuit used for providing a pulse width modulation voltage to drive a light-sensitive apparatus, so that the light-sensitive apparatus outputs an induced signal according to an external light;
a judge unit used for judging whether to operate a check and burn procedure according to an external command; and
a first analog-to-digital converter used for outputting a digital signal according to the induced signal if the check and burn procedure does not need to be operated.

2. The light-sensitive driving circuit according to claim 1, wherein the induced signal is an induced current, the light-sensitive driving circuit further comprises:
a current-to-voltage element used for converting the induced current to an induced voltage outputted to the first digit-to-analog converter, so that the first analog-to-digital converter outputs the digital signal.

3. The light-sensitive driving circuit according to claim 1, wherein the induced signal is an induced voltage, the light-sensitive apparatus comprises:
a light-sensing element used for generating an induced current according to the external light; and
a current-to-voltage element used for outputting an induced voltage according to the induced current.

4. The light-sensitive driving circuit according to claim 1, further comprises:
an output buffer used for increasing the pushing force for outputting the induced signal.

5. The light-sensitive driving circuit according to claim 1, further comprising:
a second analog-to-digital converter used for converting a first analog value and a second analog value to a first digital value and a second digital value respectively; and
a checking unit used for checking whether the difference between the first digital value and the second digital value is larger than a checking value;
a burning unit used for burning the first digital value and the second digital value to the first analog-to-digital converter to determine a first output voltage range of the first analog-to-digital converter when the difference between the first digital value and the second digital value is larger than the checking value;
wherein, the digital signal equals a first digital value when the induced signal equals a first analog value, and the induced voltage equals a second digital value when the induced signal equals a second analog value.

6. The light-sensitive driving circuit according to claim 5, wherein the first digital value is a maximum output of the first analog-to-digital converter, and the second digital value is a minimum output of the first analog-to-digital converter.

7. The light-sensitive driving circuit according to claim 5, wherein the second analog-to-digital converter converts a third analog value and a fourth analog value to a third digital value and a fourth digital value respectively, and if the difference between the third digital value and the fourth digital value is larger than the checking value, the third digital value and the fourth digital value are burnt to the first analog-to-digital converter to determine a second output voltage range and a third output voltage range of the first analog-to-digital converter;
wherein, the digital signal equals a third digital value when the induced signal equals a third analog value, and the induced voltage equals a fourth digital value when the induced signal equals a fourth analog value.

8. The light-sensitive driving circuit according to claim 1, wherein the cycle of the pulse width modulation voltage equals
$$\frac{s}{f}$$
and the working cycle of the pulse width modulation voltage equals
$$\frac{1}{4 sf} ,$$
s denotes the output times of the pulse width modulation voltage per second, and f denotes the frame updating rate.

9. The light-sensitive driving circuit according to claim 1, wherein the light-sensitive driving circuit is integrated in a display driving integrated circuit.

10. The light-sensitive driving circuit according to claim 1, wherein the light-sensitive driving circuit is formed on a display panel.

11. Alight-sensitive driving method, comprising:
(a) providing a pulse width modulation voltage to drive a light-sensitive apparatus, so that the light-sensitive apparatus outputs an induced signal according to an external light;
(b) judging whether to operate a check and burn procedure according to an external command; and
(c) outputting a digital signal according to the induced signal by a first analog-to-digital converter if the check and burn procedure does not need to be operated.

12. The light-sensitive driving method according to claim 11 wherein if the check and burn procedure needs to be operated, the light-sensitive driving method further comprises:
(d) converting a first analog value and a second analog value to a first digital value and a second digital value respectively by a second analog-to-digital converter;
(e) checking whether the difference between the first digital value and the second digital value is larger than a checking value; and
(f) burning the first digital value and the second digital value to the analog-to-digital converter to determine a first output voltage range of the analog-to-digital converter if the difference between the first digital value and the second digital value is larger than the checking value;
wherein, the digital signal equals a first digital value when the induced signal equals a first analog value, and the digital signal equals a second digital value when the induced signal equals a second analog value.

13. The light-sensitive driving method according to claim 11, wherein the first digital value is a maximum output of the analog-to-digital converter, and the second digital value is a minimum output of the analog-to-digital converter.

14. The light-sensitive driving method according to claim 11, further comprising:
(g) converting a third analog value and a fourth analog value to a third digital value and a fourth digital value respectively; and
(h) burning the third digital value and the fourth digital value to the analog-to-digital converter to determine a second output voltage range and a third output voltage range of the analog-to-digital converter f the difference between the third digital value and the fourth digital value is larger than the checking value;
wherein, the digital signal equals a third digital value when the induced signal equals a third analog value, and the digital signal equals a fourth digital value when the induced signal equals a fourth analog value.

15. The light-sensitive driving method according to claim 11, wherein the cycle of the pulse width modulation voltage equals
$$\frac{s}{f}$$
and the working cycle of the pulse width modulation voltage equals
$$\frac{1}{4 sf} ,$$
s denotes the output times of the pulse width modulation voltage per second, and f denotes the frame updating rate.

16. A display, comprising:
a display panel having a non-display area;
a light-sensitive apparatus formed within the non-display area; and
a light-sensitive driving circuit formed within the non-display area, wherein the light-sensitive driving circuit comprises:
a pulse width modulation (PWM) circuit used for providing a pulse width modulation voltage to drive the light-sensitive apparatus, so that the light-sensitive apparatus outputs an induced signal according to the external light;
a judge unit used for judging whether to operate a check and burn procedure according to an external command; and
a first analog-to-digital converter used for outputting a digital signal to dynamically adjust the backlight luminance according to the induced signal if check and burn procedure does not need to be operated.

17. The display according to claim 16, wherein the induced signal is an induced current, the light-sensitive driving circuit further comprises:
a current-to-voltage element used for converting the induced current to an induced voltage outputted to the first digit-to-analog converter, so that the first analog-to-digital converter outputs the digital signal.

18. The display according to claim 16, wherein the induced signal is an induced voltage, the light-sensitive apparatus comprises:
a light-sensing element used for generating an induced current according to the external light; and
a current-to-voltage element used for outputting an induced voltage according to the induced current.

19. The display according to claim 16, wherein the light-sensitive driving circuit further comprises:
a second analog-to-digital converter used for converting a first analog value and a second analog value to a first digital value and a second digital value respectively; and
a checking unit used for checking whether the difference between the first digital value and the second digital value is larger than a checking value, and if the difference between the second digital value and the third digital value is larger than the checking value, the first digital value and the second digital value are burnt to the first analog-to-digital converter to determine a first output voltage range of the first analog-to-digital converter;
wherein, the digital signal equals a first digital value when the induced signal equals a first analog value, and the digital signal equals a second digital value when the induced signal equals a second analog value.
